(19) United States
(12) Patent Application Publication
(10) Pub. No.: US 2010/0035203 A1
(43) Pub. Date: Feb. 11, 2010

(54) Dental Treatment Instrument with Coupling Device for Transmission of Motion and for Releasable Attachment of a Treatment Tool

(76) Inventor: Walter Moessle, Mittelbiberach (DE)

Correspondence Address: MARSHALL, GERSTEIN & BORUN LLP, 233 SOUTH WACKER DRIVE, 6300 SEARS TOWER, CHICAGO, IL, 60606-6357, US

(21) Appl. No.: 12/523,836

(22) PCT Filed: Jul. 30, 2007
(86) PCT No.: PCT/EP07/06737

§ 371 Date: Oct. 1, 2009

(30) Foreign Application Priority Data
Jan. 31, 2007 (DE) 10-2007-004-808.6

(51) Int. Cl. A61C 3/00; A61C 17/02

(52) U.S. Cl. 433/82; 433/114; 433/118

(57) ABSTRACT

In a dental treatment instrument with an elongate grip sleeve, a drive unit arranged in the grip sleeve, and a coupling device which is located at the front end of the grip sleeve and with which a movement generated by the drive unit is transferred to a treatment tool to be connected releasably to the treatment instrument, the coupling device is designed like a sleeve and has a first section for receiving a tapering peg-like coupling area of the tool shaft, and a second section which also interacts with the tool shaft to provide a securing means acting in the axial direction, wherein the length of the first section of the coupling device is at least as great as the length of the second section.

The present invention relates to a dental treatment instrument according to the precharacterizing portion of Claim 1, which exhibits a drive unit and also a coupling device which exhibits for the purpose of transmitting a motion generated by the drive unit to a treatment tool to be releasably connected to the treatment instrument. The present invention further relates to a coupling device for use in a dental treatment instrument of such a type. With this dental treatment instrument it is a question, in particular, of a so-called scaler.

In medical or dental practice a treatment or machining of the body of a human being or animal or of artificial parts thereof with a treatment instrument can be effected in a variety of ways. Ordinarily, however, a machining of the tissue is effected at least partly by means of an appropriate tool. Rotary tools such as drills or milling cutters, for example, may be employed as machining tools; use may also be made of files and other tools having at least one working surface which is two-dimensionally abrasive. In the latter case the tool is then preferentially driven in oscillatory manner by a vibrating drive. Particularly with the use of vibrating drives of such a type the problem arises that the motion generated by the drive unit, which is often of pneumatic or electromechanical construction, has to be transmitted to the treatment tool in effective manner. However, since for reasons of hygiene the tool cannot be permanently connected to the treatment instrument, use has to be made of a coupling device that enables a releasable attachment of the treatment instrument while simultaneously ensuring a reliable retention and hence a transmission of the motion.

In this context, from the earlier application DE 199 47 325 A1 by the applicant a special screw connection is known which is provided for the purpose of connecting a dental treatment tool to an instrument. An essential component is an internal thread which is provided in the coupling region formed in the manner of a sleeve, which in combination with the external thread of the tool shank enables a screw connection. By virtue of a special configuration of the internal thread, with the solution known from DE 199 47 325 A1 it is made possible that the screw connection can be established relatively quickly and simply. At the same time, the seating surfaces of the coupling region are of slightly tapering design, in order by this means to ensure the axial arrangement of the tool in the coupling region.

Now the object underlying the present invention is to specify a novel coupling device, with the aid of which the coupling between the dental treatment instrument or the drive unit of the treatment instrument and the treatment tool is optimized. On the one hand, in this case the transmission of the drive motion is to be further improved; on the other hand, however, the handling is also to be simplified. In particular in this regard, the establishing of the connection between treatment instrument and treatment tool and also the later release are to be simplified.

The object is achieved by a dental treatment instrument that exhibits the features of Claim 1. Advantageous further developments of the invention are the subject-matter of the dependent claims.

The solution according to the invention is based firstly on the idea of optimizing the transmission of motion by means of a power-flux connection between coupling device and treatment tool. For this purpose the invention provides that the coupling device formed in the manner of a sleeve firstly exhibits a first portion for receiving a tapering, plug-like coupling region of the tool shank, this portion having a defined length, as will be specified later in more detail. Accordingly, a relatively large-area abutment surface between tool shank and coupling device is created, by virtue of which the transmission of motion and the retention are improved. However, in order at the same time also to avoid an unintentional release of the tool in operation, the invention further provides that the coupling device exhibits a second portion, likewise acting in combination with the tool shank, which is designed to form a safety lock acting in the axial direction. By virtue of this safety lock, which, for example, may be designed in the form of a screw connection or a bayonet connection, the linkage—as will be elucidated later in more detail—of the tool to the treatment instrument is additionally improved. Furthermore, the attaching or releasing of the tool is facilitated, since in the case of a screw connection or bayonet connection the safety lock simultaneously also constitutes a support when releasing the tool.

In accordance with the invention, a dental treatment instrument is accordingly proposed that exhibits an elongated gripping sleeve, a drive unit arranged in the gripping sleeve and also a coupling device, located at the front end of the gripping sleeve, for transmitting a motion generated by the drive unit to a treatment tool to be releasably connected to the treatment instrument, the coupling device being formed in the manner of a sleeve and exhibiting a first portion for receiving a tapering plug-like coupling region of the tool shank and also a second portion, likewise acting in combination with the tool shank, for forming a safety lock acting in the axial direction, and the length of the first portion of the coupling device being at least equal to the length of the second portion.

According to an advantageous further development of the invention, there is provision that the first portion of the coupling device is designed to receive a frustoconical tool shank. The cone angle in this case may be between 0.01° and 10°, preferentially within the range between 0.5° and 2°. By virtue of this relatively shallow angle, a large abutment surface is created between coupling device and tool shank, by virtue of which the retention of the tool and also the transmission of motion are improved.

The coupling device may furthermore exhibit a passage channel for supplying a treatment medium to the treatment tool. On this path, air and/or water, for example, can be conducted to the treatment site in later operation. As already mentioned, the drive unit is preferentially constituted by an oscillating drive. The treatment instrument further constitutes, in particular, a so-called scaler.

The invention will be elucidated in more detail in the following on the basis of the accompanying drawings. Shown are:

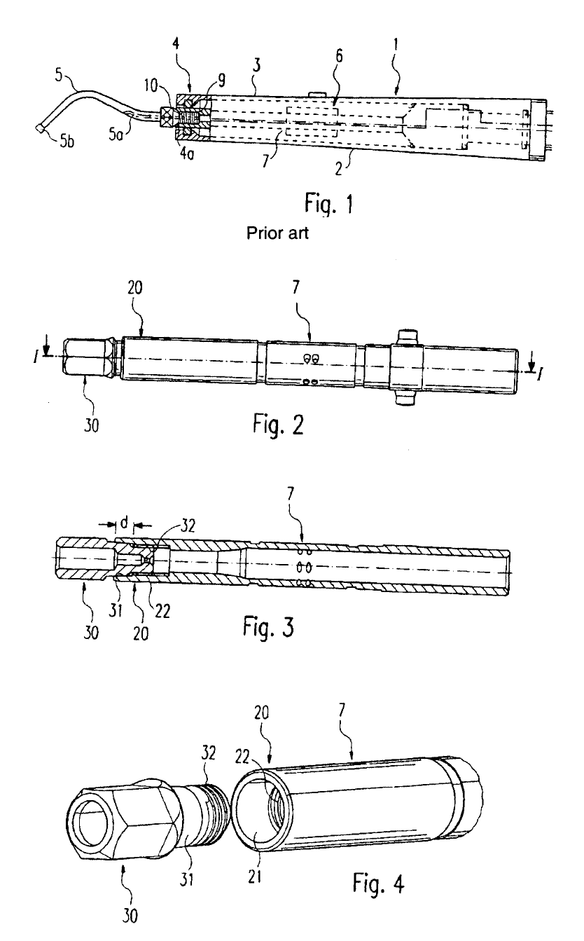

FIG. 1 the general configuration of a conventional scaler;

FIG. 2 the side view of an oscillation generator with a coupling device located at the front end for releasable retention of a treatment tool;

FIG. 3 a section I-I from FIG. 2;

FIG. 4 a perspective view of the front end of the oscillation generator with the tool tip released;

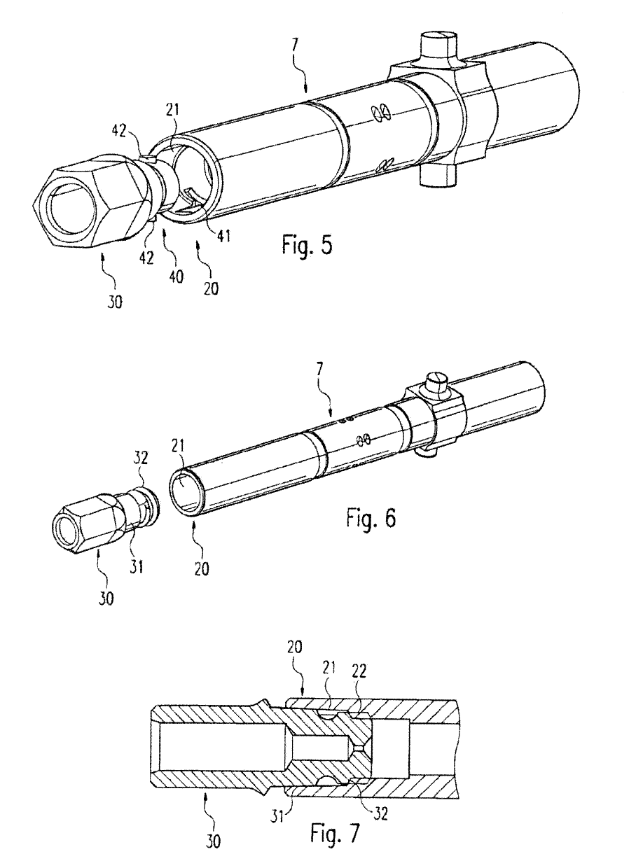

FIG. 5 a first variant of a coupling device according to the invention;

FIG. 6 a second variant of a coupling device according to the invention and

FIG. 7 the front end region of the coupling device according to FIG. 6 in section.

FIG. 1 shows, firstly, the general configuration of a conventional scaler, in this case a coupling between drive unit and treatment tool being present such as is known from the prior art. The main elements of the scaler which is provided with reference symbol 1 are an elongated or rod-shaped handpiece 2 with a gripping sleeve 3, in the front end region of which a retaining or coupling device 4 for retaining a treatment tool 5 with a tool shank 5a is arranged. Within the gripping sleeve 3 a vibrating drive 6 is arranged, which is intended to bring about an oscillatory motion of the tool 5. The preferably pneumatically or electromechanically designed vibrating drive 6 exhibits for this purpose an oscillation generator 7 which, given appropriate operation of the drive unit, generates an oscillating motion with a frequency of, for example, 4 kHz to 8 kHz or within the ultrasonic range, which is transmitted to the tool 5. By means of a working tip 5b of the tool 5, which exhibits an abrasive surface, tartar can then be abraded from the surface of the tooth.

For reasons of hygiene it is necessary that the tool 5 be removed and cleaned or sterilized after each treatment carried out. Accordingly, the tool 5 has to be releasably connected to the oscillation generator 7, this being effected with the aid of the coupling device 4 which is formed at the front end of the oscillation generator 7. In the embodiment according to the prior art, the coupling device 4 exhibits an internal thread 9 which acts in combination with an external thread 10 of the rear tool-shank portion in the sense of a screw connection. So the tool 5 can accordingly be screwed onto the front end of the treatment instrument 1. A central arrangement of the tool shank in the coupling device 4 configured in the form of a sleeve is ensured by virtue of the fact that the front end faces 4a of the coupling device 4 are formed in conically tapering manner and act in combination with a truncated-cone portion of the tool shank.

Starting from this known configuration of a scaler, a novel coupling device is now proposed, by virtue of which, on the one hand, the transmission of the motion of the oscillation generator to the tool is optimized. On the other hand, the handling is simplified, particularly with regard to the attachment and release of the tool. A first embodiment of a coupling device according to the invention will now be elucidated in the following on the basis of FIGS. 2 to 4.

The central idea of the present invention is, firstly, that the transmission of motion is optimized by enlargement of the abutment surface between coupling device and tool shank. For this purpose the coupling device exhibits a first portion for receiving a tapering plug-like coupling region of the tool shank. The coupling region of the tool shank may be, in particular, of frustoconical design, so that given appropriate configuration of the first portion a conical snug fit results between tool shank and coupling device. Given a suitable dimensioning of this abutment region, solely by reason of the matched shapes of coupling device and tool shank and by reason of the static friction obtaining in this case, a sufficiently stable retention of the tool would obtain, provided that the abutment surfaces are designed to be sufficiently smooth. However, since—particularly in operation in dentistry—it can never be completely ruled out that small particles of dust or other particles are deposited within the abutment region, which at start-up of the oscillation generator or in the event of a change of frequency could result in an unintentional release of the tool, the invention further provides that the coupling device exhibits a second portion which is provided for acting in combination with the tool shank, in order to form a safety lock acting in the axial direction.

As FIGS. 2 to 4 now show, in which, primarily, the oscillation generator 7 with the coupling device 20, configured in accordance with the invention and located at the front end, and also the rear end of the tool shank 30 are represented, the coupling device 20 formed in the manner of a sleeve exhibits in the end region an opening for inserting the tool shank 30 with a slightly tapering portion 21 with a smooth inner surface. This first portion 21 acts in combination with the frustoconical region 31 of the tool shank 30. This first portion 21 of the coupling device 20 is furthermore adjoined by an internal thread 22 which acts in combination with a corresponding frontal external thread 32 of the tool shank 30.

What is important is, firstly, that the aperture angle γ of the first portion 21 of the coupling device 20 is relatively small and lies merely within the range between 0.01° and 10°. Furthermore, the axial length d of the first portion 21 is at least equal to the length of the second portion 22 with the internal thread. It may lie, for example, within the range between I mm and 15 mm. This has the result that the retention of the tool and also the transmission of motion are primarily effected via the abutment surfaces of the first portion 21 of the coupling device 20 and also of the frustoconical tool-shank region 31. The task of the screw connection is merely to make available an additional safety lock in the axial direction, by virtue of which the tool—for whatever reason—is prevented from being released unintentionally during operation. For this, a relatively simple screw connection is sufficient, which extends merely over a short length of the front end region.

Another function of the screw connection consists furthermore also in that by this means the release of the tool from the oscillation generator 7 is simplified. If the connection were merely to be effected by an accurately fitting seating of the tool shank in the cone-like first portion 21 of the coupling device 20, the tool would have to be withdrawn with a high expenditure of force in the axial direction. Occasionally it would even be necessary to bring about a release of the tool by gentle impacts. Measures of such a type, however, are not now necessary, since as a result of a simultaneous twisting of the tool an axial motion is brought about by reason of the screw connection, by which the frictional engagement between the abutment surfaces is released. The screw drive accordingly provides for an additional alleviation of the handling of the instrument.

It is to be noted, furthermore, that the coupling device as well as the tool shank may also exhibit mutually corresponding channels, by which a media line extending through the treatment instrument as far as the tool tip is formed, which can be utilized for supplying air and/or water or another treatment medium during the treatment.

FIG. 5 shows a first variant of a coupling device according to the invention. In this case the axial safety lock is designed in the form of a bayonet catch 40. Guideways 41 for inserting the pins 42 protruding laterally on the tool shank 30 are accordingly provided within the first portion 21 of the coupling device 20. This bayonet connection 40 constitutes a particularly simple type of safety lock acting against an unintentional release of the tool, whereby, however, the release and attachment of the tool to the oscillation generator 7 are kept particularly simple. Instead of the form represented, with two laterally protruding pins 42, it would also be conceivable to provide merely a single pin which provides for a safety lock in the axial direction in the sense of a bayonet connection.

Finally, FIGS. 6 and 7 show a third variant of a coupling device 20 according to the invention. In this case a screw thread which is kept particularly simple is provided, which, however, is likewise sufficient in order to bring about a safety lock in the axial direction. Again it should be pointed out that this thread may be formed very simply in the sense of a quick-closing connection, for example as a double-start thread, since the transmission of force and of motion are brought about primarily by the seating of the frustoconical region 31 of the tool shank 30 in the first portion 21 of the coupling device 20.

In conclusion, it remains to be noted that the sequence between the first portion and the second portion of the coupling device could be also reversed. In other words, it would also be conceivable that the internal thread for realizing the axial safety lock is provided directly on the front region of the oscillation generator, and that the slightly tapering first portion for receiving the plug-like coupling region of the tool shank is formed only following on from this. In this variant too, on the one hand an optimal transmission of force is ensured, and on the other hand the handling of the treatment instrument is simplified.

1. A dental treatment instrument comprising an elongated gripping sleeve, with a drive unit arranged in the gripping sleeve, and a coupling device located at a front end of the gripping sleeve for transmitting a motion generated by the drive unit to a treatment tool to be releasably connected to the treatment instrument,
wherein
the coupling device is a sleeve and comprises
a) a first portion for receiving a tapering plug-like coupling region of the tool shank and
b) a second portion for acting in combination with the tool shank to form a safety lock acting in an axial direction,
the length (d) of the first portion of the coupling device being at least equal to the length of the second portion of the coupling device.

2. A dental treatment instrument according to claim 1,
wherein
the first portion of the coupling device is designed to receive a frustoconical tool-shank portion.

3. A dental treatment instrument according to claim 2,
wherein
the first portion defines an aperture angle (γ) of between 0.01° and 10°.

4. A dental treatment instrument according to claim 3, wherein
the aperture angle is about 0.5° to 2°.

5. A dental treatment instrument according to claim 1, wherein
the safety lock acting in the axial direction comprises a screw connection.

6. A dental treatment instrument according to claim 1, wherein
the safety lock acting in the axial direction comprises a bayonet connection.

7. A dental treatment instrument according to claim 1, wherein
the coupling device exhibits a passage channel for supplying a treatment medium to the treatment tool.

8. A dental treatment instrument according to claim 1, wherein
the drive unit is an oscillation generator.

9. A dental treatment instrument according to claim 8,
wherein
the treatment instrument is a scaler.

10. A combination consisting of a dental treatment instrument according to claim 1 and a tool to be releasably connected to the treatment instrument.

11. A coupling device for use in a dental treatment instrument, which is provided for the purpose of transmitting a motion generated by a drive unit of the treatment instrument to a treatment tool to be releasably connected to the treatment instrument,
wherein
the coupling device is a sleeve and comprises
a) a first portion for receiving a tapering plug-like coupling region of the tool shank and
b) a second portion for acting in combination with the tool shank to form a safety lock acting in an axial direction,
a length of the first portion of the coupling device being at least equal to a length of the second portion.
